(19) United States
(12) Patent Application Publication
(10) Pub. No.: US 2011/0187630 A1
(43) Pub. Date: Aug. 4, 2011

(54) ACTIVE ELEMENT ARRAY SUBSTRATE AND FLAT DISPLAY USING THE SAME

(75) Inventors: Shi-Fang Chen, Hsinchu City (TW); Shyh-Liang Lin, Hsinchu City (TW)

(73) Assignee: E Ink Holdings Inc., Hsinchu City (TW)

(21) Appl. No.: 12/837,969

(22) Filed: Jul. 16, 2010

(30) Foreign Application Priority Data
Jan. 29, 2010 (TW) 099102721

(51) Int. Cl. G09G 3/34

(52) U.S. Cl. 345/84

(57) ABSTRACT

An active element array substrate includes a plurality of scan lines, a plurality of data lines, a plurality of pixel transistors and a plurality of pixel electrodes. The data lines are intersected with the scan lines. Each of the pixel transistors is electrically coupled to corresponding one of the scan lines and corresponding one of the data lines respectively, and each of the pixel electrodes is electrically coupled to one of the corresponding pixel transistors respectively. Furthermore, each of the pixel electrodes includes an alloy having nickel and boron.

### BACKGROUND

This application claims priority to a Taiwan application No. 099102721 filed Jan. 29, 2010.

1. Technical Field

The present invention relates to an array substrate for a display device, more particularly to an active element array substrate and a flat panel display using the same.

2. Description of the Related Art

With the rapid progress of display technologies, flat panel display has been widely used in various kinds of display areas. The common flat panel display includes liquid crystal display (LCD), plasma display, organic electro-luminescence display, electrophoretic display and so on. According to the source of the light required for displaying images, the flat panel display can be classified in reflective display and transmissive display. Because of low power consumption and compact size, the reflective display has become a kind of important flat panel display.

The conventional reflective flat panel display utilizes transparent conductive material as pixel electrode, and forms a reflective layer below the pixel electrode for reflecting light. However, because the pixel electrode made of transparent conductive material can not shield light, the amorphous silicon channel layer of the pixel transistors for driving each pixel of the flat panel display will be illuminated and then a leakage current occurs, which will damage the flat panel display.

### BRIEF SUMMARY

The present invention is to provide an active element array substrate, which can prevent pixel transistors from generating leakage current.

The present invention is to also provide a flat panel display, which can prevent pixel transistors from generating leakage current.

In order to achieve one or part of or all the objectives or other objectives, in an embodiment of the present invention, an active element array substrate is provided. The active element array substrate includes a plurality of scan lines, a plurality of data lines, a plurality of pixel transistors and a plurality of pixel electrodes. The data lines are intersected with the scan lines. Each of the pixel transistors is electrically coupled to corresponding one of the scan lines and corresponding one of the data lines respectively, and each of the pixel electrodes is electrically coupled to one of the corresponding pixel transistors respectively. Furthermore, each of the pixel electrodes includes an alloy having nickel and boron.

In order to achieve one or part of or all the objectives or other objectives, in an embodiment of the present invention, a flat panel display is also provided. The flat panel display includes an active element array substrate, a top substrate opposite to the active element array substrate, and a display layer sandwiched between these two substrates. The active element array substrate includes a plurality of scan lines, a plurality of data lines, a plurality of pixel transistors and a plurality of pixel electrodes. The data lines are intersected with the scan lines. Each of the pixel transistors is electrically coupled to corresponding one of the scan lines and corresponding one of the data lines respectively, and each of the pixel electrodes is electrically coupled to one of the corresponding pixel transistors respectively. Furthermore, each of the pixel electrodes includes an alloy having nickel and boron.

In an embodiment of the present invention, each of the pixel transistors includes a channel layer, and each of the pixel electrodes is disposed on the channel layer of corresponding one of the pixel transistors.

In an embodiment of the present invention, each of the pixel transistors is a thin film transistor.

In an embodiment of the present invention, each of the pixel transistors includes a gate electrode, a source electrode, and a drain electrode. The gate electrode of each of the pixel transistors is electrically coupled to corresponding one of the scan lines, while the source electrode of each of the pixel transistors is electrically coupled to corresponding one of the data lines, and the drain electrode of each of the pixel transistors is electrically coupled to corresponding one of the pixel electrodes. Furthermore, the source electrode, the drain electrode and the pixel electrode are made of the same materials.

In an embodiment of the present invention, the display layer is an electrophoretic display layer.

In an embodiment of the present invention, the weight percent of boron is between 0.05% and 0.2%, and is preferably 0.1%.

In the embodiment of the present invention, the pixel electrodes are made of opaque alloy having nickel and boron. Therefore, the pixel electrodes are capable of reflecting the light sufficiently and shielding all of the external light so as to prevent the pixel transistors from being illuminated by the light and further prevent the pixel transistors from generating a leakage current.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a flat panel display according to an embodiment of the present invention.

FIG. 2 is a schematic view of an active element array substrate of FIG. 1.

FIG. 3 is a schematic cross-sectional view of a pixel area of FIG. 2.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

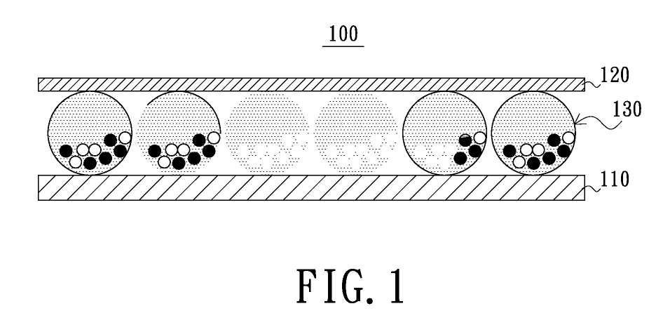

FIG. 1 is a schematic view of a flat panel display according to an embodiment of the present invention. In this embodiment, the electrophoretic display is illustrated as an example for description of the present invention. As known for ordinary skilled people in the art, the flat panel display may be reflective flat panel displays of other types, such as liquid crystal display. Referring to FIG. 1, the flat panel display 100 includes an active element array substrate 110, a top substrate 120 opposite to the active element array substrate 110, and a display layer 130 sandwiched between the active element array substrate 110 and the top substrate 120. In this embodiment, the display layer 130 is an electrophoretic display layer, and the top substrate 120 may be a color filter.

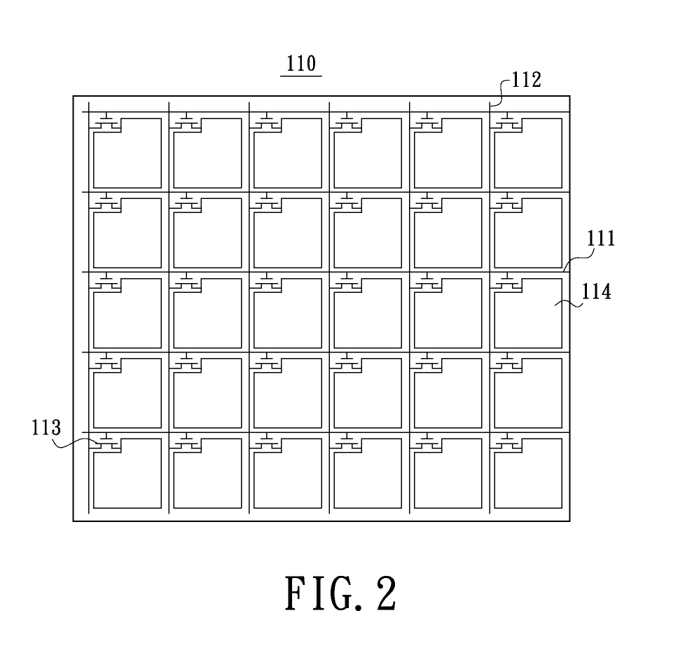

FIG. 2 is a schematic view of the active element array substrate of FIG. 1. Referring to FIG. 2, the active element array substrate 110 includes a plurality of scan lines 111, a plurality of data lines 112, a plurality of pixel transistors 113 and a plurality of pixel electrodes 114. The scan lines 111 are intersected with the data lines 112, and thereby a plurality of pixel areas are formed (not shown). Each of the pixel areas has a pixel transistor 113 and a pixel electrode 114. Each of the pixel transistors 113 is electrically coupled to corresponding one of the scan lines 111 and corresponding one of the data lines 112 respectively, and each of the pixel electrodes 114 is electrically coupled to one of the corresponding pixel transistors 113 respectively. In this embodiment, the pixel transistor 113 may be a thin film transistor (TFT). As know for ordinary skilled people in the art, the pixel transistor 113 may be other kind of transistors, such as metal oxide semiconductor field effect transistor (MOSFET).

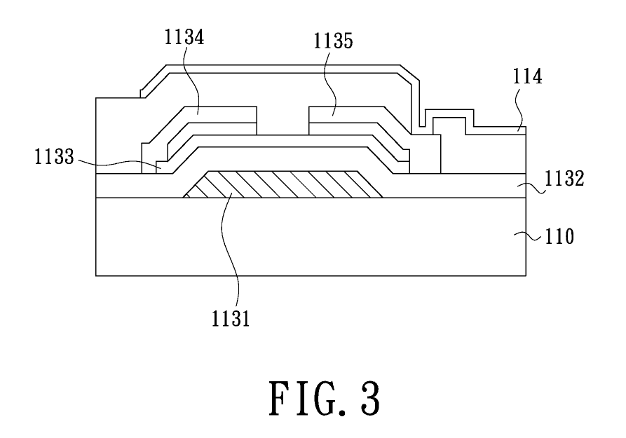

FIG. 3 is a schematic, cross sectional view of a pixel area of FIG. 2. Referring to FIG. 3, the pixel transistor 113 is disposed on the active element array substrate 110, and includes a gate electrode 1131, a gate electrode insulation layer 1132, a channel layer 1133, a source electrode 1134 and a drain electrode 1135. The source electrode 1134, the drain electrode 1135 and the pixel electrode 114 are made of the same materials. Also referring to FIG. 2 and FIG. 3, the gate electrode 1131 of each of the pixel transistors 113 is electrically coupled to corresponding one of the scan lines 111, while the source electrode 1134 of each of the pixel transistors 113 is electrically coupled to corresponding one of the data lines 112, and the drain electrode 1135 of each of the pixel transistors 113 is electrically coupled to corresponding one of the pixel electrodes 114. It should be noted that, the channel layer 1133 of this embodiment is, for example, made of amorphous silicon. The pixel electrode 114 is disposed on the channel layer 1133 for preventing the channel layer 1133 from being illuminated by the external light, further preventing the pixel electrode 114 from generating a leakage current.

The flat panel display 100 transfers corresponding scan signals to each of the pixel transistors 113 through the scan lines 111 so as to determine each of the pixel transistors 113 is turning on or not, and transfers the corresponding data signals to corresponding one of pixel electrodes 114 through the data lines 112 and the conducted pixel transistors 113 for displaying images on the flat panel display 100. In this embodiment, the pixel electrodes 114 are made of opaque alloy having nickel and boron, wherein the weight percent of boron is between 0.05% and 0.2%, and is preferably 0.1%, for reflecting light to prevent the light from illuminating on the channel layer 1133 of the pixel transistor 113.

In summary, the pixel electrodes of the present invention are made of opaque alloy having nickel and boron. Therefore, the pixel electrodes are capable of reflecting the light sufficiently and shielding all of the external light so as to prevent the pixel transistors from being illuminated by the light and further preventing the pixel transistors from generating a leakage current. Furthermore, as known for ordinary skilled people in the art, the gate electrode, the source electrode, the drain electrode and the pixel electrode may be made of the same materials, which further shielding the external light.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An active element array substrate comprising:
a plurality of scan lines;
a plurality of data lines intersected with the scan lines;
a plurality of pixel transistors, and each of the pixel transistors being electrically coupled to corresponding one of the scan lines and corresponding one of the data lines respectively; and
a plurality of pixel electrodes, and each of the pixel electrodes being electrically coupled to one of the corresponding pixel transistors respectively, wherein each of the pixel electrodes comprises an alloy having nickel and boron.

2. The active element array substrate as claimed in claim 1, wherein each of the pixel transistors comprises a channel layer, and each of the pixel electrodes is disposed on the channel layer of corresponding one of the pixel transistors.

3. The active element array substrate as claimed in claim 1, wherein each of the pixel transistors is a thin film transistor.

4. The active element array substrate as claimed in claim 1, wherein each of the pixel transistors comprises:
a gate electrode electrically coupled to corresponding one of the scan lines;
a source electrode electrically coupled to corresponding one of the data lines; and
a drain electrode electrically coupled to corresponding one of the pixel electrodes, wherein the source electrode, the drain electrode and the pixel electrode are made of the same materials.

5. The active element array substrate as claimed in claim 1, wherein the weight percent of boron of each of the pixel electrodes is between 0.05% and 0.2%.

6. The active element array substrate as claimed in claim 5, wherein the weight percent of boron of each of the pixel electrodes is 0.1%.

7. A flat panel display comprising:
an active element array substrate comprising:
a plurality of scan lines;
a plurality of data lines intersected with the scan lines;
a plurality of pixel transistors, and each of the pixel transistors being electrically coupled to corresponding one of the scan lines and corresponding one of the data lines respectively; and
a plurality of pixel electrodes, and each of the pixel electrodes being electrically coupled to one of the corresponding pixel transistors respectively, wherein each of the pixel electrodes comprises an alloy having nickel and boron;
a top substrate opposite to the active element array substrate; and
a display layer sandwiched between the active element array substrate and the top substrate.

8. The flat panel display as claimed in claim 7, wherein the display layer is an electrophoretic display layer.

9. The flat panel display as claimed in claim 7, wherein each of the pixel transistors comprises a channel layer, and each of the pixel electrodes is disposed on the channel layer of corresponding one of the pixel transistors.

10. The flat panel display as claimed in claim 7, wherein each of the pixel transistors is a thin film transistor.

11. The flat panel display as claimed in claim 7, wherein each of the pixel transistors comprises:
a gate electrode electrically coupled to corresponding one of the scan lines;
a source electrode electrically coupled to corresponding one of the data lines; and
a drain electrode electrically coupled to corresponding one of the pixel electrodes, wherein the source electrode, the drain electrode and the pixel electrode are made of the same materials.

12. The flat panel display as claimed in claim 7, wherein the weight percent of boron of each of the pixel electrodes is between 0.05% and 0.2%.

13. The flat panel display as claimed in claim 12, wherein the weight percent of boron of each of the pixel electrodes is 0.1%.
